(19) United States
(12) Patent Application Publication
(10) Pub. No.: US 2005/0174488 A1
(43) Pub. Date: Aug. 11, 2005

(54) Methods, devices, and systems for displaying information from a remote electronic device

(76) Inventor: Sandeep Chennakeshu, Malmo (SE)

Correspondence Address: Scott C. Hatfield;Myers Bigel Sibley & Sajovec, Post Office Box 37428, Raleigh, NC, 27627, US

(21) Appl. No.: 10/655,422

(22) Filed: Sep. 4, 2003

Related U.S. Application Data
(60) Provisional application No. 60/453,443, filed on Mar. 10, 2003.

(51) Int. Cl. H04N 5/38

(52) U.S. Cl. 348/552; 348/723

(57) ABSTRACT

Information from a handheld electronic device can be shown on a video screen that is remote from the electronic device. More particularly, information can be provided within a handheld electronic device, and communicated from the handheld electronic device to a receiver over a wireless coupling. A video signal is generated responsive to the information communicated over the wireless coupling, and the video signal is provided for display on the video screen. More particularly, the information can be communicated over the wireless coupling according to a Bluetooth protocol. Related methods, systems, and devices are discussed.

### RELATED APPLICATIONS

The present application claims priority from U.S. Provisional Application No. 60/453,443, filed Mar. 10, 2003, the disclosure of which is hereby incorporated herein in its entirety by reference.

### BACKGROUND

The present invention relates to the field of electronics and more particularly to methods, devices, and systems for displaying information.

While many handheld electronic devices such as radiotelephones and personal digital assistants continue to get smaller, the desire to display greater amounts of information is increasing. Accordingly, a demand for ever larger displays may be in conflict with a demand for ever smaller handheld electronic devices. For example, increased use of text messaging in cellular communications systems may increase demand for larger mobile terminal displays to facilitate use and/or viewing of this information.

### SUMMARY

According to embodiments of the present invention, information from a handheld electronic device can be displayed on a video screen remote from the handheld electronic device. More particularly, information can be received from the handheld electronic device over a wireless coupling. Responsive to receiving the information from the handheld electronic device, a video signal corresponding to the information from the handheld electronic device can be generated. The video signal can then be provided to the video screen, thereby allowing the information to be shown on the video screen.

According to additional embodiments of the present invention, information can be provided within a handheld electronic device wherein the provided information is adapted for display on a local display of the handheld electronic device. The information can then be transmitted from the handheld electronic device over a wireless coupling to a receiver for displaying on the video screen remote from the handheld electronic device.

### BRIEF DESCRIPTION OF THE DRAWINGS

FIG. 1 is a block diagram illustrating systems, methods, and devices for remote display of information according to embodiments of the present invention.

FIG. 2 is a block diagram illustrating handheld electronic devices and methods according to embodiments of the present invention.

FIG. 3 is a block diagram illustrating video signal generators and methods according to embodiments of the present invention.

FIG. 4 is a block diagram illustrating radiotelephones and methods according to embodiments of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods or devices. Accordingly, the present invention may take the form of a hardware embodiment, a software embodiment or an embodiment combining software and hardware aspects. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A display of a handheld electronic device (such as a radiotelephone or a personal digital assistant) can be used to provide visual information to a user of the handheld electronic device. In a radiotelephone, for example, a display on the body of the radiotelephone can show a telephone number dialed, a telephone number of a calling party (caller identification), information from an electronic address book stored in the radiotelephone, calendar information, e-mail, text messages, screens for electronic games, photographs, pictures, video clips, internet pages, etc. The size of the display of the handheld electronic device, however, may be limited by the size of the electronic device. Accordingly, some of the information may be difficult to view on the relatively small display typically provided on a handheld electronic device.

According to embodiments of the present invention, information typically shown on the display of the handheld electronic device can be transmitted via a wireless coupling to a video signal generator that generates a video signal so that the transmitted information can be shown on a video screen remote from the handheld electronic device. By way of example, the video signal generator can provide the video signal to a television so that information from the handheld electronic device is displayed on the television screen. Alternately, the video signal generator could provide the video signal to other video screens, such as a computer monitor, flat panel display, cathode ray tube, liquid crystal display, etc. Moreover, the wireless coupling between the handheld electronic device and the video signal generator can be provided, for example, using the Bluetooth protocol. The Bluetooth protocol is discussed, for example, by Sailesh Rathi in the reference entitled “Blue Tooth Protocol Architecture” from Dedicated Systems Magazine, 2000 Q4, pages 28-33, the disclosure of which is hereby incorporated herein in its entirety by reference.

The video signal generator can be implemented as a part of a set-top-box, for example, that is coupled with a television or other video screen. The coupling between a set-top-box and a television, for example, can be provided by a coaxial cable. Accordingly, methods, systems, and devices according to embodiments of the present invention can be used with a conventional television or computer monitor. Alternately, a video signal generator according to embodiments of the present invention can be integrated into a television or computer system so that no separate set-top-box is required. For example, a personal computer could have a Bluetooth transceiver for wireless reception from the handheld device and software to convert the information for display on the personal computer monitor.

A user of a handheld electronic device can thus use the relatively small display of the handheld electronic device according to conventional modes of operation, and/or use a larger video screen to view information normally provided on the smaller display of the handheld electronic device. For example, information from the handheld electronic device can be wirelessly transmitted to a nearby television so that the information is shown on the television in addition to or instead of being shown on the smaller display of the handheld electronic device. Because of the pervasive availability of televisions in the United States, a user of a handheld electronic device may be able to more easily and conveniently view information from the handheld electronic device on a home television during much of the time that the handheld electronic device is being used.

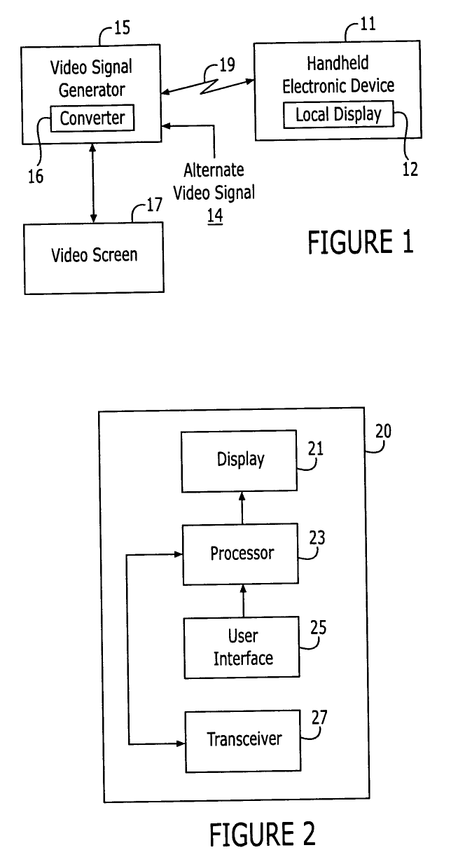

As shown in FIG. 1, systems, methods, and devices according to embodiments of the present invention may include a handheld electronic device 11, a video signal generator 15 remote from the handheld electronic device 11, and a video screen 17 communicatively coupled to the video signal generator 15. When the handheld electronic device 11 is within range of the video signal generator 15, a wireless coupling 19 can be used to communicate information from the handheld electronic device 11 to the video signal generator 15. The wireless coupling 19, for example, can be provided according to the bluetooth protocol. Other wireless couplings, however, can be used.

According to embodiments of the present invention, for example, the information from the handheld electronic device 11 may be displayed on the video screen 17 for viewing by the user of the handheld electronic device while operating the handheld electronic device, so that a long range wireless coupling is not required. Accordingly, a short range wireless coupling (such as that provided according to the Bluetooth protocol) may be used according to embodiments of the present invention.

When within range of the video signal generator 15 and within sight of the video screen 17, the user of the handheld electronic device can operate the handheld electronic device 11 using the video screen 17 to view information to/from the handheld electronic device 11. When not within range of the video signal generator 15 and/or when privacy is desired, the user can operate the handheld electronic device using a smaller local display 12 of the handheld electronic device to view information. The video screen 17, for example, can be used to view an e-mail received at the handheld electronic device, to view game screens for a game being played on the handheld electronic device, to view an intemet page down loaded to the handheld electronic device, to view a photograph stored in the handheld electronic device, to view a video clip stored in the handheld electronic device, etc.

When the video signal generator 15 receives the information from the handheld electronic device 11 over the wireless coupling 19, the video signal generator 15 generates a video signal corresponding to the information from the handheld electronic device and provides the video signal to the video screen in a format allowing the information to be shown/viewed/displayed on the video screen. In other words, the video signal generator 15 may include a converter 16 that converts the information received from the handheld electronic device 11 to a video signal suitable for display of the information on the video screen 17. In addition to the information received from the handheld electronic device over the wireless coupling 19, the video signal can include one or more of a horizontal line sync pulse, a color reference burst, a reference black level, a picture luminance level, color saturation information, color hue information, and/or a vertical sync pulse. Moreover, the video signal can include all of the elements of a NTSC (National Television System Committee) color television video signal for compatibility with a conventional color television. If the information from the handheld electronic device is a still image such as an e-mail, photograph, picture, or internet page, a composite video signal can be created and repeated at the frame rate for the applicable television standard so that the still image can be shown on a conventional television screen. While the NTSC standard has been discussed above, other video standards such as component video, S-video, DVD (Digital Video Disk), PAL (Phase Alternation by Line), SECAM (Sequential Colour with Memory), and HDTV (High Definition Television) can be used by the video signal generator.

The video signal generator 15 may also generate a beacon allowing the handheld electronic device 11 to determine if it is within range of the video signal generator 15. If within range, the handheld electronic device can automatically transmit the information over the wireless coupling 19 for display on the remote video screen 17. Alternately, the handheld electronic device 11 may require user input before transmitting video information over the wireless coupling 19 so that information is not transmitted inadvertently to the remote video screen 17. According to a combination of aspects of these two features, the handheld electronic device may prompt the user to use the video screen when the handheld electronic device determines that it is within range of the video signal generator, and, responsive to the prompt, the user can then elect transmission over the wireless coupling, if desired.

In addition, the information can be shown on the local display 12 of the handheld electronic device 11 concurrently with showing the information on the remote video screen 17. Alternately, the information can be blocked from the local display 12 of the handheld electronic device when shown on the video screen 17. Moreover, a handheld electronic device 11 may enable either mode of operation with the user providing selection thereof.

According to some embodiments of the present invention, a user can play an electronic game on the handheld electronic device while viewing game screens on the remote video screen. Alternately, the user can view pictures, video clips, e-mails, etc. stored in and/or received by the handheld electronic device on the remote video screen. Moreover, the user can view information from the handheld electronic device on the video screen without requiring a wired coupling to the handheld electronic device. Accordingly, the handheld electronic device 11 may remain portable while using the display 17.

According to additional embodiments of the present invention, the video screen 17 and/or the video signal generator 15 can automatically select a video feed for the video screen. For example, the video signal from the converter 16 can be automatically selected for display on the video screen 17 when information from a handheld electronic device is received over the wireless coupling 19. When there is an automatic selection, an alternate video signal 14 (such as that from a cable TV input) can be automatically provided to the video screen 17 when video information from a handheld electronic device is not being received. Alternately, a user selection may be required to switch between a video input from the converter 16 and the alternate video signal 14. The switch may occur in the video signal generator 15 such that either the video signal from the converter 16 or from the alternate video signal 14 is output from the video signal generator 15 to the video screen 17. Alternately, the alternate video input may be provided directly to the video screen and the switch may occur at the video screen such that the video screen can switch between the video signal from the converter or the alternate video signal. Alternatively converter 16 can put either the video from the handheld as a view box within alternate video signal 14, or vice versa.

Handheld electronic devices according to additional embodiments of the present invention are further illustrated in FIG. 2. As shown, a handheld electronic device 20 according to embodiments of the present invention can include a display 21, a processor 23, a user interface 25, and a transceiver 27. The display 21 provides a visual output, the user interface 25 can provide user inputs and/or outputs, and the transceiver 27 is configured to provide a wireless coupling to a video signal generator as discussed above with regard to FIG. 1. The processor 23 is configured to control operation of one or more of the other blocks 21, 25, 27 responsive to, for example, user input from the user interface 25 and/or information received from the transceiver 27. The handheld electronic device, for example, can be a personal digital assistant and/or a radiotelephone such as a mobile terminal for use in a cellular communications system.

Where the handheld electronic device is a radiotelephone, the user interface 25 may include a keypad, a speaker, and/or a microphone. Moreover, the display 21 may be considered a part of the user interface 25, and a keypad may be implemented as a touch sensitive surface of the display 21. The display 21 can be a relatively small screen used to show a number being dialed, show a number of a calling party (caller identification), show information from an electronic address book, show game screens, show photographs/pictures, show calendar information, e-mails, etc. Where the handheld electronic device 20 is a personal digital assistant without radiotelephone features, the display can be used to show corresponding information not directly related to radiotelephone operations. Moreover, handheld electronic devices can be implemented incorporating both radiotelephone and personal digital assistant functionalities and/or different functionalities.

As discussed above with regard to FIG. 1, a user of the handheld electronic device 20 can operate the handheld electronic device conventionally using only the local display 21. Because the display 21 may be relatively small, however, the user may desire to view information on a larger video screen. Accordingly, the transceiver 27 can be used to transmit information over a wireless coupling to a video signal generator coupled to a larger video screen. Moreover, the transceiver 27 may also support reception of a beacon from a video signal generator allowing the processor 23 to determine when a video signal generator is within range of the handheld electronic device.

When implemented in a handheld electronic device that does not otherwise support wireless communications, the transceiver 27 may be dedicated to providing short range wireless couplings such as with a video signal generator as discussed above. For example, the transceiver 27 may be dedicated to providing short range wireless couplings according to the Bluetooth protocol. Moreover, the transceiver may support short range wireless couplings with devices in addition to a video signal generator. When implemented in handheld communications devices supporting other wireless communications, the transceiver may support other communications such as radiotelephone communications, e-mail communications, text messaging communications, paging, etc. Alternately, one or more additional transceivers may be provided to support other wireless communications.

Accordingly, a user of the handheld electronic device 20 can operate the handheld electronic device while viewing information from the handheld electronic device on a remote video screen. In other words, information from the handheld electronic device can be viewed on a video screen without requiring a wired coupling between the handheld electronic device and the video screen. Moreover, the wireless coupling from the handheld electronic device can be provided by a short range wireless protocol such as Bluetooth. Accordingly, the user of the handheld electronic device may be able to easily switch between using the smaller on-board display 21 and a larger remote video screen based on the availability of a larger remote video screen, privacy concerns, user preference, etc.

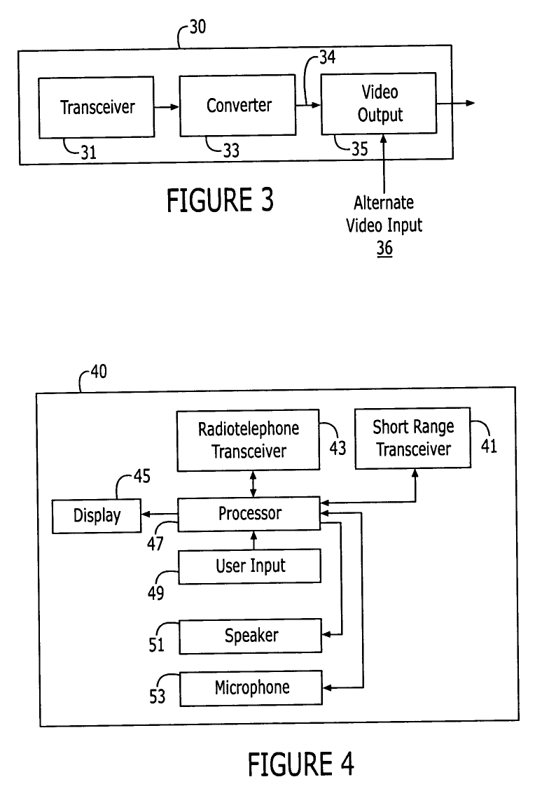

As shown in FIG. 3, a video signal generator 30 according to embodiments of the present invention may include a transceiver 31, a converter 33, and a video output 35. The transceiver 31 is configured to receive information over a wireless coupling from a handheld electronic device, the converter 33 is configured to generate a video signal corresponding to the information received from the handheld electronic device, and the video output 35 is configured to provide the video signal to a video screen. The video output 35, for example, can be a cable output or other output for coupling with a video screen.

As discussed above, the transceiver 31 can support a short range wireless coupling such as a wireless coupling according to the Bluetooth protocol. While the flow of information discussed above may be primarily from the handheld electronic device to the video signal generator, the transceiver 31 may also provide for transmission. For example, the transceiver 31 may provide a beacon allowing a compatible handheld electronic device to determine that it is within range of the video signal generator 30. In addition, the transceiver 31 may transmit acknowledgements of receipt of information from a handheld electronic device and/or indications of transmission failures.

The converter 33 generates a video signal corresponding to information received from a handheld electronic device. As discussed above, the video signal can be generated according to a conventional video standard such as the NTSC standard, a component video standard, an S-video standard, the DVD standard, the PAL standard, the SECAM standard, and the HDTV standard. Accordingly, the video signal can include one or more of a horizontal line sync pulse, a color reference burst, a reference black level, a picture luminance level, color saturation information, color hue information, and a vertical sync pulse. In the alternative, the converter 33 can generate a video signal in compliance with other video standards to provide compatibility with a desired video screen.

The video output 35 provides the video output signal 34 from the processor 33 to a video screen. The video output, for example, can provide a coupling with a coaxial cable for connection to a cable video input of a television. Other wired or wireless couplings, however, can be used between the video output and a video screen.

The video output 35 can also be used to select a video feed to the video screen. For example, the video output 35 can select between the video signal 34 based on information received from a handheld electronic device or an alternate video input 36 such as a cable TV signal, a satellite TV signal, or a local broadcast TV signal. The selection can be based on instructions received from the handheld electronic device via the transceiver 31, or based on user input such as through a button, switch, or other user input at the video signal generator 30. The selection could also be automatic such that the video output 35 selects the video signal based on information from a handheld electronic device any time such a video signal is available. Alternatively, the signals from these two sources, 34 and 36, can be merged in any number of ways. For instance video 34 could be a box within video source 36.

Moreover, the video signal generator 30 may be implemented within a unit such as a set-top-box separate from a video screen to which it is coupled, or the video signal generator and the video screen may be integrated into a single device. The video signal generator 30, for example, may be implemented in a set-top-box by itself or in combination with receivers for one or more of cable TV signals, satellite TV signals, and/or local broadcast TV signals. Alternately, the video signal generator 30 may be integrated into a television or a computer system. In addition, a video signal generator 30 may receive wireless information from electronic devices other than handheld electronic devices for display on a video screen according to embodiments of the present invention. For example, the video signal generator may receive information over a wireless coupling from a VCR (video cassette recorder), DVD (digital video disk) player, a cable television box, or from some other information source.

Radiotelephones according to embodiments of the present invention are illustrated in FIG. 4. As shown, a radiotelephone 40 according to embodiments of the present invention can include a short range transceiver 41, a radiotelephone transceiver 43, a display 45, a processor 47, a user input 49, and a speaker 51, and a microphone 53. The display 45 provides a visual output. The user input 49 can include a keypad, a touch sensitive portion of the display, and/or a dial or other input. The short range transceiver 41 can provide a wireless coupling to a video signal generator 15, 30 as discussed above, for example, with regard to FIGS. 1 and 3. The radiotelephone transceiver 43 can provide wireless coupling with a radiotelephone communications system to facilitate voice communications, facsimile communications, e-mail, text messaging, etc. The speaker 51 and the microphone 53 may provide for voice communications. The short range transceiver 41 can provide a short range wireless coupling with a video signal generator as discussed above. The processor 47 controls operation of the other blocks responsive to user input and/or any information received through the transceiver 41 and/or the transceiver 43.

A user interface of the radiotelephone 40 may be defined to include the user input 49, the speaker 51, the microphone 53, and the display 45. The display 45 can be a relatively small screen used to show a number being dialed, show a number of a calling party (caller identification), show information from an electronic address book, show game screens, show photographs/pictures, show calendar information, e-mails, etc. As discussed above with regard to FIG. 1, a user of the radiotelephone 40 can operate the radiotelephone conventionally using only the local display 45. Because the display 45 may be relatively small, however, the user may desire to view information on a larger video screen. Accordingly, the short range transceiver 41 can be used to transmit information over a wireless coupling to a video signal generator coupled to a larger video screen. Moreover, the short range transceiver 41 may also support reception of a beacon from a video signal generator allowing the processor 47 to determine when a video signal generator is within range of the handheld electronic device.

The short range transceiver 41 may be dedicated to providing short range wireless couplings such as with a video signal generator as discussed above. For example, the short range transceiver 41 may be dedicated to providing short range wireless couplings according to the Bluetooth protocol. Moreover, the short range transceiver 41 can also be operated to transmit and receive information other than that to be shown on a display or video screen and/or with devices other than a video signal generator. When implemented as a Bluetooth transceiver, for example, the short range transceiver 41 may also be used to provide wireless coupling to an external ear piece, an external microphone, a computer, an external keyboard, etc. While illustrated as being separate blocks, the short range transceiver and the radiotelephone transceiver may be implemented as an integrated transceiver. Alternately, separate transceivers may be provided to support the different communications.

Accordingly, a user of the radiotelephone 40 can operate the radiotelephone while viewing information from the radiotelephone on a remote video screen. In other words, information from the radiotelephone can be viewed on a video screen without requiring a physical coupling between the handheld electronic device and the video screen. Moreover, the wireless coupling from the radiotelephone can be provided by a short range wireless protocol such as Bluetooth. Accordingly, the user of the radiotelephone can easily switch between using the smaller local display 45 and a larger remote video screen based on the availability of a larger remote video screen, privacy concerns, user preference, etc.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of displaying information from a handheld electronic device on a video screen remote from the handheld electronic device, the method comprising:
receiving information from the handheld electronic device over a wireless coupling;
responsive to receiving the information from the handheld electronic device, generating a video signal corresponding to the information from the handheld electronic device; and
providing the generated video signal to the video screen for display of the information on the video screen.

2. A method according to claim 1 wherein the information from the handheld electronic device comprises at least one selected from the group consisting of an e-mail received by the handheld electronic device, a game screen for a game being played on the handheld electronic device, an internet page received by the handheld electronic device, a photograph, and a video clip.

3. A method according to claim 1 wherein receiving the information from the handheld electronic device comprises receiving the information according to a Bluetooth wireless protocol.

4. A method according to claim 1 wherein the video signal further comprises at least one selected from the group consisting of a horizontal line sync pulse, a color reference burst, a reference black level, picture luminance information, color saturation information, color hue information, and a vertical sync pulse.

5. A method according to claim I wherein the handheld electronic device comprises a radiotelephone.

6. A method according to claim 1 wherein the handheld electronic device comprises a personal digital assistant.

7. A method according to claim 1:
wherein receiving information from the handheld electronic device is preceded by determining if information is being received from the handheld electronic device;
wherein the operations of receiving the information from the handheld electronic device, generating the video signal, and providing the video signal to the video screen are performed responsive to determining that information is being transmitted from the handheld electronic device; and
wherein the method further comprises providing an alternate video to the video screen responsive to determining that information is not being transmitted from the handheld electronic device.

8. A method according to claim 1 wherein the video screen comprises a television.

9. A method according to claim 1 wherein the handheld electronic device includes a local display mounted in a housing of the handheld electronic device and wherein the local display is small relative to the remote video screen.

10. A method according to claim 13 further comprising:
showing the information on the local display of the handheld electronic device concurrently with showing the information on the remote video screen.

11. A video signal generator comprising:
a receiver configured to receive information from a handheld electronic device over a wireless coupling;
a processor configured to generate a video signal corresponding to the information from the handheld electronic device responsive to receiving the information from the handheld electronic device; and
a video output configured to provide the video signal to a video screen for display on the video screen.

12. A video signal generator according to claim 11 wherein the receiver is configured to receive the information according to a Bluetooth wireless protocol.

13. A video signal generator according to claim 11 wherein the video signal further comprises at least one signal selected from the group consisting of a horizontal line sync pulse, a color reference burst, a reference black level, picture luminance information, color saturation information, color hue information, and a vertical sync pulse.

14. A video signal generator according to claim 11 wherein the handheld electronic device comprises at least one of a radiotelephone and a personal digital assistant.

15. A video signal generator according to claim 11 wherein the video output is further configured to provide an alternate video signal to the video screen if information is not being received from the handheld electronic device.

16. A method of displaying information from a handheld electronic device on a video screen remote from the handheld electronic device, the method comprising:
generating information within the handheld electronic device wherein the generated information is adapted for display on a local display of the handheld electronic device; and
transmitting the generated information from the handheld electronic device over a wireless coupling to a receiver for display on the remote video screen remote.

17. A method according to claim 16 further comprising:
displaying the information on the local display of the handheld electronic device concurrently with transmitting the information from the handheld electronic device over the wireless coupling.

18. A method according to claim 16:
wherein transmitting the information is preceded by determining at the handheld electronic device that the receiver is within a transmission range of the handheld electronic device wherein transmitting the information is performed responsive to a determination that the receiver is within range; and
displaying the information on the display of the handheld electronic device responsive to a determination that no receiver is within range of the handheld electronic device.

19. A method according to claim 16 wherein the information from the handheld electronic device comprises at least on selected from the group consisting of an e-mail received by the handheld electronic device, a game screen for a game being played on the handheld electronic device, an interned page received by the handheld electronic device, a photograph, and a video clip.

20. A method according to claim 16 wherein transmitting the information from the handheld electronic device comprises transmitting the information according to a Bluetooth wireless protocol.

21. A method according to claim 16 wherein the handheld electronic device comprises at least one selected from the group consisting of a radiotelephone and a personal digital assistant.

22. A method according to claim 16 wherein the video screen comprises a television.

23. A method according to claim 16 wherein the display of the handheld electronic device is small relative to the video screen.

24. A handheld electronic device comprising:
a local display mounted on a housing of the display;
a processor coupled to the display wherein the processor is configured to generate information within the handheld electronic device wherein the information is adapted for display on the local display of the handheld electronic device; and
a transceiver coupled to the processor wherein the transceiver is configured to transmit the generated information from the handheld electronic device over a wireless coupling to a receiver for display on a video screen remote from the handheld electronic device.

25. A handheld electronic device according to claim 24 wherein the information is shown on the local display of the handheld electronic device concurrently with transmitting the information from the handheld electronic device over the wireless coupling.

26. A handheld electronic device according to claim 24 wherein the processor displays the information on the local display of the handheld electronic device when no receiver is within range of the handheld electronic device.

27. A handheld electronic device according to claim 24 wherein the transceiver transmits the information from the handheld electronic device according to a Bluetooth wireless protocol.

28. A handheld electronic device according to claim 24 wherein the handheld electronic device comprises at least one selected from the group consisting of a radiotelephone and a personal digital assistant.

29. A handheld electronic device according to claim 24 wherein the local display of the handheld electronic device is small relative to the video screen.

30. A method of displaying information on a video screen from a handheld electronic device including a display wherein the video screen is remote from the handheld electronic device, the method comprising:
providing information within the handheld electronic device;
communicating the information from the handheld electronic device to a receiver over a wireless coupling;
generating a video signal responsive to the information communicated over the wireless coupling;
providing the video signal to the remote video screen; and
displaying the information on the video screen.

31. A method according to claim 30 wherein the information is communicated from the handheld electronic device to the receiver over the wireless coupling according to a Bluetooth wireless protocol.

32. A method according to claim 30 wherein the handheld electronic device comprises at least one of a radiotelephone and a personal digital assistant.

33. A method of displaying information from an electronic device on a video screen remote from the electronic device, the method comprising the steps of:
receiving information from the electronic device over a wireless coupling according to a Bluetooth protocol;
responsive to receiving the information from the electronic device, converting the information from the electronic device to a video signal; and
providing the video signal to the remote video screen for display of the information on the remote video screen.

34. A method according to claim 33 wherein the video signal further comprises at least one selected from the group consisting of a horizontal line sync pulse, a color reference burst, a reference black level, picture luminance information, color saturation information, color hue information, and a vertical sync pulse.

35. A method according to claim 33 wherein the video screen comprises a television.
